(19) United States
(12) Patent Application Publication
(10) Pub. No.: US 2025/0310946 A1
(43) Pub. Date: Oct. 2, 2025

(54) FREQUENCY DOMAIN RESOURCE DETERMINING METHOD, TERMINAL, AND NETWORK SIDE DEVICE

(71) Applicant: VIVO MOBILE COMMUNICATION CO., LTD., Dongguan (CN)

(72) Inventors: Zhi LU, Dongguan (CN); Lihui WANG, Dongguan (CN)

(73) Assignee: VIVO MOBILE COMMUNICATION CO., LTD., Dongguan (CN)

(21) Appl. No.: 19/236,978

(22) Filed: Jun. 12, 2025

Related U.S. Application Data
(63) Continuation of application No. PCT/CN2023/136966, filed on Dec. 7, 2023.

(30) Foreign Application Priority Data
Dec. 13, 2022 (CN) 202211606774.X

(51) Int. Cl. H04W 72/0453; H04L 5/00

(52) U.S. Cl. CPC H04W 72/0453; H04L 5/0098

(57) ABSTRACT

A frequency domain resource determining method, a terminal, and a network side device are provided. The frequency domain resource determining method includes: when a frequency domain resource scheduled by a network side device overlaps at least one of a first subband or a GB, determining, by a communication device, valid PRBs of the frequency domain resource based on a first mode or a second mode; and determining, by the communication device, a TBS based on the valid PRBs, and performing information transmission based on the TBS. The frequency domain resource is located in a first BWP, a transmission direction of the first subband is different from a transmission direction of the first BWP. The first mode includes: ignoring PRBs overlapping the at least one of the first subband or the GB in the frequency domain resource, and determining remaining PRBs as valid PRBs.

### CROSS-REFERENCE TO RELATED APPLICATIONS

This application is a continuation of International Application No. PCT/CN2023/136966, filed on Dec. 7, 2023, which claims priority to Chinese Patent Application No. 202211606774. X, filed on Dec. 13, 2022. The entire contents of each of the above-referenced applications are expressly incorporated herein by reference.

### TECHNICAL FIELD

This application relates to the field of communication technologies, and specifically relates to a frequency domain resource determining method, a terminal, and a network side device.

### BACKGROUND

When an uplink (UL) subband is configured in a downlink (DL) Bandwidth Part (BWP), a frequency domain resource scheduled in the downlink BWP may be affected by an uplink subband or a Guard Band (GB) due to existence of the uplink subband or the guard band, thereby reducing resource utilization.

### SUMMARY

Embodiments of this application provide a frequency domain resource determining method, a terminal, and a network side device.

According to a first aspect, a frequency domain resource determining method is provided, including: when a frequency domain resource scheduled by a network side device overlaps at least one of a first subband or a GB, determining, by a communication device, valid PRBs of the frequency domain resource based on a first mode or a second mode; and determining, by the communication device, a TBS based on the valid PRBs, and performing information transmission based on the TBS, where the frequency domain resource is located in a first BWP, a transmission direction of the first subband is different from a transmission direction of the first BWP, and the first mode includes: ignoring PRBs overlapping the at least one of the first subband or the GB in the frequency domain resource, and determining remaining PRBs as valid PRBs; and the second mode includes: skipping PRBs overlapping the at least one of the first subband or the GB until a quantity of valid PRBs is equal to a target PRB quantity.

According to a second aspect, a frequency domain resource determining method is provided, including: when a second subband configured by a network side device overlaps at least one of a third subband or a GB, determining, by a communication device, a size of the second subband based on a third mode or a fourth mode, where a transmission direction of the second subband is different from a transmission direction of the third subband, and the third mode includes: discarding a PRB overlapping the at least one of the third subband or the GB in the second subband, and determining the size of the second subband based on remaining PRBs; and the fourth mode includes: determining the size of the second subband based on a configuration of the network side device.

According to a third aspect, a frequency domain resource determining apparatus is provided, including: a determining module, configured to: when a frequency domain resource scheduled by a network side device overlaps at least one of a first subband or a GB, determine valid PRBs of the frequency domain resource based on a first mode or a second mode; and a transmission module, configured to: determine a TBS based on the valid PRBs, and perform information transmission based on the TBS, where the frequency domain resource is located in a first BWP, a transmission direction of the first subband is different from a transmission direction of the first BWP, and the first mode includes: ignoring PRBs overlapping the at least one of the first subband or the GB in the frequency domain resource, and determining remaining PRBs as valid PRBs; and the second mode includes: skipping PRBs overlapping the at least one of the first subband or the GB until a quantity of valid PRBs is equal to a target PRB quantity.

According to a fourth aspect, a frequency domain resource determining apparatus is provided, including: a determining module, configured to: when a second subband configured by a network side device overlaps at least one of a third subband or a GB, determine a size of the second subband based on a third mode or a fourth mode, where a transmission direction of the second subband is different from a transmission direction of the third subband, and the third mode includes: discarding a PRB overlapping the at least one of the third subband or the GB in the second subband, and determining the size of the second subband based on remaining PRBs; and the fourth mode includes: determining the size of the second subband based on a configuration of the network side device.

According to a fifth aspect, a terminal is provided. The terminal includes a processor and a memory, the memory stores a program or an instruction that can be run on the processor, and the program or the instruction is executed by the processor to implement the steps of the method according to the first aspect or the second aspect.

According to a sixth aspect, a terminal is provided, including a processor and a communication interface. The processor is configured to: when a frequency domain resource scheduled by a network side device overlaps at least one of a first subband or a GB, determine valid PRBs of the frequency domain resource based on a first mode or a second mode; and the communication interface is configured to: determine a TBS based on the valid PRBs, and perform information transmission based on the TBS, where the frequency domain resource is located in a first BWP, a transmission direction of the first subband is different from a transmission direction of the first BWP, and the first mode includes: ignoring PRBs overlapping the at least one of the first subband or the GB in the frequency domain resource, and determining remaining PRBs as valid PRBs; and the second mode includes: skipping PRBs overlapping the at least one of the first subband or the GB until a quantity of valid PRBs is equal to a target PRB quantity. In some embodiments, the processor is configured to: when a second subband configured by a network side device overlaps at least one of a third subband or a GB, determine a size of the second subband based on a third mode or a fourth mode, where a transmission direction of the second subband is different from a transmission direction of the third subband, and the third mode includes: discarding a PRB overlapping the least one of the third subband or the GB in the second subband, and determining the size of the second subband based on remaining PRBs; and the fourth mode includes: determining the size of the second subband based on a configuration of the network side device.

According to a seventh aspect, a network side device is provided. The network side device includes a processor and a memory, the memory stores a program or an instruction that can be run on the processor, and the program or the instruction is executed by the processor to implement the steps of the method according to the first aspect or the second aspect. According to an eighth aspect, a network side device is provided, including a processor and a communication interface. The processor is configured to: when a frequency domain resource scheduled by a network side device overlaps at least one of a first subband or a GB, determine valid PRBs of the frequency domain resource based on a first mode or a second mode; and the communication interface is configured to: determine a TBS based on the valid PRBs, and perform information transmission based on the TBS, where the frequency domain resource is located in a first BWP, a transmission direction of the first subband is different from a transmission direction of the first BWP, and the first mode includes: ignoring PRBs overlapping the at least one of the first subband or the GB in the frequency domain resource, and determining remaining PRBs as valid PRBs; and the second mode includes: skipping PRBs overlapping the a least one of the first subband or the GB until a quantity of valid PRBs is equal to a target PRB quantity. In some embodiments, the processor is configured to: when a second subband configured by a network side device overlaps at least one of a third subband or a GB, determine a size of the second subband based on a third mode or a fourth mode, where a transmission direction of the second subband is different from a transmission direction of the third subband, and the third mode includes: discarding a PRB overlapping the at least one of the third subband or the GB in the second subband, and determining the size of the second subband based on remaining PRBs; and the fourth mode includes: determining the size of the second subband based on a configuration of the network side device.

According to a ninth aspect, a frequency domain resource determining system is provided, including a terminal and a network side device. The terminal may be configured to perform the steps of the method according to the first aspect or the second aspect, and the network side device may be configured to perform the steps of the method according to the first aspect or the second aspect.

According to a tenth aspect, a readable storage medium is provided. The readable storage medium stores a program or an instruction, and the program or the instruction is executed by a processor to implement the steps of the method according to the first aspect or the steps of the method according to the second aspect.

According to an eleventh aspect, a chip is provided. The chip includes a processor and a communication interface, the communication interface is coupled to the processor, and the processor is configured to run a program or an instruction to implement the steps of the method according to the first aspect or implement the steps of the method according to the second aspect.

According to a twelfth aspect, a computer program/program product is provided. The computer program/program product is stored in a storage medium, and the computer program/program product is executed by at least one processor to implement the steps of the method according to the first aspect or the steps of the method according to the second aspect.

In the embodiments of this application, when a frequency domain resource scheduled by a network side device overlaps a first subband and/or a GB, the frequency domain resource is located in a first BWP, and a transmission direction of the first subband is different from a transmission direction of the first BWP, a communication device may ignore PRBs overlapping the first subband and/or the GB in the frequency domain resource, and determine remaining PRBs as valid PRBs; or a communication device skips PRBs overlapping the first subband and/or the GB until a quantity of valid PRBs is equal to a target PRB quantity; and the communication device determines a TBS based on the valid PRB, and performs information transmission based on the TBS. In the embodiments of this application, the frequency domain resource scheduled by the network side device can be fully utilized, thereby improving utilization of the frequency domain resource. In addition, in the embodiments of this application, full-duplex configurations that meet different service volume requirements in NR can be implemented, thereby improving system resource utilization and reducing a delay.

### BRIEF DESCRIPTION OF DRAWINGS

FIG. 1 is a schematic diagram of a wireless communication system according to an embodiment of this application;

FIG. 2 is a schematic flowchart of a frequency domain resource determining method according to an embodiment of this application;

FIG. 3 is a schematic flowchart of a frequency domain resource determining method according to an embodiment of this application;

FIG. 4 is a schematic application diagram of a frequency domain resource determining method according to an embodiment of this application;

FIG. 5 is a schematic application diagram of a frequency domain resource determining method according to an embodiment of this application;

FIG. 6 is a schematic application diagram of a frequency domain resource determining method according to an embodiment of this application;

FIG. 7 is a schematic application diagram of a frequency domain resource determining method according to an embodiment of this application;

FIG. 8 is a schematic structural diagram of a frequency domain resource determining apparatus according to an embodiment of this application;

FIG. 9 is a schematic structural diagram of a frequency domain resource determining apparatus according to an embodiment of this application;

FIG. 10 is a schematic structural diagram of a communication device according to an embodiment of this application;

FIG. 11 is a schematic structural diagram of a terminal according to an embodiment of this application; and

FIG. 12 is a schematic structural diagram of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In the specification and claims of this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to applications other than an NR system application, such as a 6th Generation (6G) communication system.

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an ultra-mobile personal computer (UMPC), a Mobile Internet Device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station, a WLAN access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the field. As long as a same technical effect is achieved, the base station is not limited to a specified technical term. It should be noted that, in this application, only a base station in an NR system is used as an example, and a specific type of the base station is not limited.

With reference to the accompanying drawings, the following describes in detail the frequency domain resource determining method provided in the embodiments of this application by using some embodiments and application scenarios thereof.

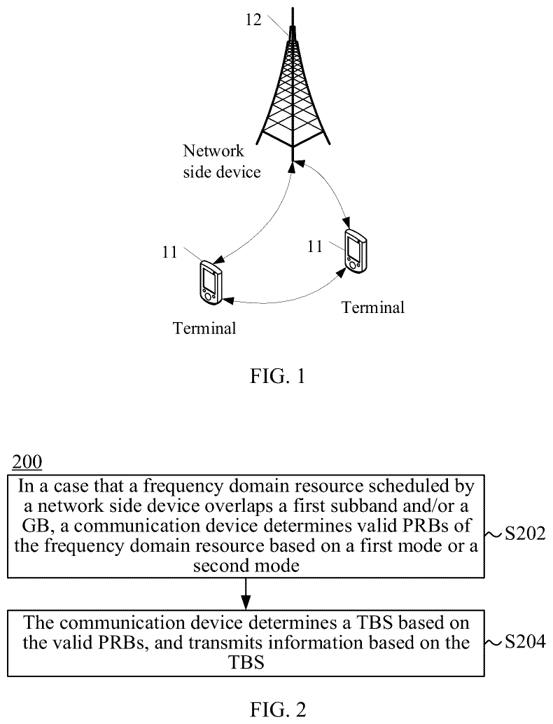

As shown in FIG. 2, an embodiment of this application provides a frequency domain resource determining method 200. The method may be executed by a communication device. In other words, the method may be executed by software or hardware installed in the communication device. The communication device may be a terminal or a network side device. The method includes the following steps.

S202. In a case that a frequency domain resource scheduled by a network side device overlaps a first subband and/or a Guard Band (GB), a communication device determines valid Physical Resource Blocks (PRBs) of the frequency domain resource based on a first mode or a second mode.

The frequency domain resource is located in a first Band Width Part (BWP), a transmission direction of the first subband is different from a transmission direction of the first BWP, and the first mode includes: ignoring PRBs overlapping the first subband and/or the GB in the frequency domain resource, and determining remaining PRBs as valid PRBs; and the second mode includes: skipping PRBs overlapping the first subband and/or the GB until a quantity of valid PRBs is equal to a target PRB quantity.

S204. The communication device determines a Transport Block Size (TBS) based on the valid PRB, and performs information transmission based on the TBS.

This embodiment of this application may be applied to a subband non-overlapping full duplex (SBFD) scenario.

The frequency domain resource scheduled by the network side device is located in the first BWP. The first BWP may be a downlink BWP, and the first subband is an uplink subband, that is, an uplink subband is configured in a downlink carrier, and the transmission direction of the first subband is different from (that is, opposite to) the transmission direction of the first BWP; or the first BWP may be an uplink BWP, and the first subband is a downlink subband, that is, a downlink subband is configured in an uplink carrier, and the transmission direction of the first subband is different from (that is, opposite to) the transmission direction of the first BWP.

For example, an allocation type of the frequency domain resource is a continuous resource allocation type, such as a frequency resource allocation type 1 (type 1).

For example, before S202, the network side device may configure a frequency domain location and a size of the first subband and a frequency domain location and a size of the GB; or the network side device configures a frequency domain location and a size of the first subband and a size of the GB, where the GB may be located at one end or both ends of the first subband by default; or the terminal implicitly determines a frequency domain location and a size of the GB based on a frequency domain location and a size of the first subband.

In this embodiment, the communication device may determine the valid PRB of the scheduled frequency domain resource based on the first mode or the second mode.

In the first mode, the communication device ignores the PRBs overlapping the first subband and/or the GB in the frequency domain resource, and determines the remaining PRBs as the valid PRBs. For example, the frequency domain resource scheduled by the network side device includes four PRBs: a PRB 1, a PRB 2, a PRB 3, and a PRB 4. The PRB 3 is configured as a GB, and the PRB 4 is configured as a part of the first subband. In this case, the PRB 3 and the PRB 4 respectively overlap the GB and the first subband. The communication device determines that the PRB 1 and the PRB 2 are valid PRBs.

In the second mode, that is, the communication device skips the PRBs overlapping the first subband and/or the GB until the quantity of valid PRBs is equal to the target PRB quantity.

For example, the target PRB quantity includes one of the following:

(1) A PRB quantity indicated in frequency domain resource allocation, where the frequency domain resource allocation may be indicated by scheduling signaling for scheduling the frequency domain resource, which applies hereinafter.

(2) A product of a PRB quantity indicated in frequency domain resource allocation and a scaling factor, where the scaling factor may be configured by the network side device, for example, 0.8 or 0.7.

(3) A reference quantity closest to a PRB quantity indicated in frequency domain resource allocation, where the reference quantity is configured or indicated by the network side device. In this example, the network side device may configure or indicate a plurality of reference quantities, and the terminal may determine one reference quantity closest to the PRB quantity indicated in the frequency domain resource allocation.

For example, the skipping PRBs overlapping the first subband and/or the GB until a quantity of valid PRBs is equal to a target PRB quantity includes: skipping, based on a frequency domain direction (for example, from a low frequency to a high frequency or from a high frequency to a low frequency) configured by the network side device, the PRBs overlapping the first subband and/or the GB until the quantity of valid PRBs is equal to the target PRB quantity.

According to the frequency domain resource determining method provided in this embodiment of this application, in a case that a frequency domain resource scheduled by a network side device overlaps a first subband and/or a GB, the frequency domain resource is located in a first BWP, and a transmission direction of the first subband is different from a transmission direction of the first BWP, a communication device may ignore PRBs overlapping the first subband and/or the GB in the frequency domain resource, and determine remaining PRBs as valid PRBs; or a communication device skips PRBs overlapping the first subband and/or the GB until a quantity of valid PRBs is equal to a target PRB quantity; and the communication device determines a TBS based on the valid PRB, and performs information transmission based on the TBS. In this embodiment of this application, the frequency domain resource scheduled by the network side device can be fully utilized, thereby improving utilization of the frequency domain resource. In addition, in this embodiment of this application, full-duplex configurations that meet different service volume requirements in NR can be implemented, thereby improving system resource utilization and reducing a delay.

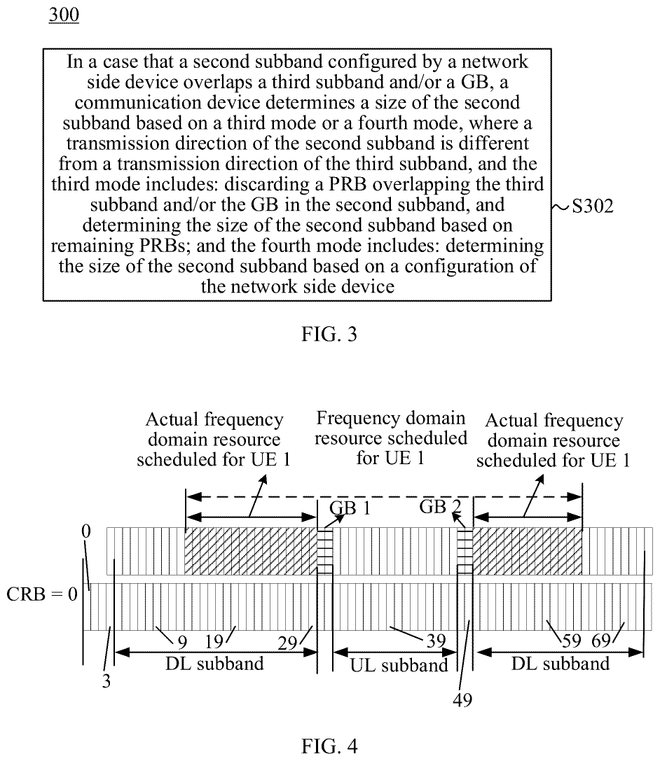

As shown in FIG. 3, an embodiment of this application further provides a frequency domain resource determining method 200. The method may be executed by a communication device. In other words, the method may be executed by software or hardware installed in the communication device. The communication device may be a terminal or a network side device. The method includes the following step.

S302. In a case that a second subband configured by a network side device overlaps a third subband and/or a GB, a communication device determines a size of the second subband based on a third mode or a fourth mode, where a transmission direction of the second subband is different from a transmission direction of the third subband, and the third mode includes: discarding a PRB overlapping the third subband and/or the GB in the second subband, and determining the size of the second subband based on remaining PRBs; and the fourth mode includes: determining the size of the second subband based on a configuration of the network side device.

In this embodiment, the second subband is configured by the network side device; and the third subband and/or the GB may be configured or indicated by the network side device.

In this embodiment, the second subband may be an uplink subband, the third subband may be one of a plurality of downlink subbands of a downlink BWP, and the transmission direction of the second subband is different from (that is, opposite to) the transmission direction of the third subband; or the second subband may be a downlink subband, the third subband may be one of a plurality of uplink subbands of the uplink BWP, and the transmission direction of the second subband is different from (that is, opposite to) the transmission direction of the third subband.

In this embodiment, the communication device may determine the size of the second subband based on the third mode or the fourth mode.

In the third mode, the communication device discards the PRB overlapping the third subband and/or the GB in the second subband, and determines the size of the second subband based on the remaining PRBs. For example, the communication device determines a size of the remaining PRBs as the size of the second subband.

In the fourth mode, the communication device determines the size of the second subband based on the configuration of the network side device. In this embodiment, the terminal may receive indication information from the network side device, where the indication information may be used to indicate the size of the second subband.

For example, the method further includes: determining, by the communication device, the second subband as a valid subband of a Channel State Information (CSI) reporting band, and calculating CSI based on the CSI reporting band. That is, the terminal considers a resource of the second subband when calculating the CSI.

For example, the method further includes: transmitting or receiving, by the communication device, configuration information, where the configuration information is used to configure at least one of the following: (1) the size of the second subband; and (2) a frequency domain location of the second subband. For example, when the communication device is a terminal, the terminal receives the configuration information. When the communication device is a network side device, the network side device transmits the configuration information.

According to the frequency domain resource determining method provided in this embodiment of this application, in a case that a second subband configured by a network side device overlaps a third subband and/or a GB, and a transmission direction of the second subband is different from a transmission direction of the third subband, a communication device may discard a PRB overlapping the third subband and/or the GB in the second subband, and determine a size of the second subband based on remaining PRBs; or a communication device determines a size of the second subband is determined based on a configuration of the network side device. In this embodiment of this application, a frequency domain resource of a subband configured by the network side device can be fully utilized, thereby improving utilization of the frequency domain resource. In addition, in this embodiment of this application, full-duplex configurations that meet different service volume requirements in NR can be implemented, thereby improving system resource utilization and reducing a delay.

To describe in detail the frequency domain resource determining method provided in the embodiments of this application, the following provides description with reference to several specific embodiments.

### Embodiment 1

Manner 1 is mainly described in this embodiment.

As shown in FIG. 4, a bandwidth of a BWP is 70 PRBs, and a start PRB is 3 (relative to a common PRB-common PRB). A network configures a location of a UL subband as a PRB 32 to a PRB 47, with a total of 16 PRBs. GBs are PRBs 30 to 31 and PRBs 48 to 49.

As shown in FIG. 4, frequency domain resources scheduled or semi-statically configured by a network for UE 1 are PRBs 13 to 63 (which are described based on a CRB number for simplicity). In this embodiment, the UE removes unavailable PRBs overlapping the UL subband or the GBs, that is, determines a quantity of PRBs that are expected to be allocated by the network, determines a TBS based on the PRB quantity, and performs a rate matching operation.

Because the PRBs occupied by the UL subband and the GBs are not used for data transmission, actually used resources, that is, valid PRBs are PRBs 13 to 29 and PRBs 50 to 63.

### Embodiment 2

In this embodiment, UE does not expect downlink continuous frequency resource allocation indicated by a network to overlap a UL subband or a GB because this method may reduce frequency resource utilization on the UE side.

### Embodiment 3

Manner 2 is mainly described in this embodiment.

When a network configures a UL subband and/or a GB, and x PRBs are scheduled or configured for UE by using a continuous frequency resource allocation type (that is, a type 1), the UE considers x as a quantity of actually used frequency PRBs, and the UE determines a TBS based on the PRB quantity and performs a rate matching operation.

The UE skips PRBs overlapping the UL subband and the GB in a frequency domain direction configured by the network until a quantity of valid DL PRBs is equal to a PRB quantity indicated in frequency domain resource allocation. In this example, the frequency domain direction configured by the network is from a low frequency to a high frequency. If scheduled frequency domain resources overlap the UL subband and/or the GB by y PRBs, the UE ignores the part overlapping the UL subband or the GB, and determines the allocated y PRBs on a DL subband with a high frequency.

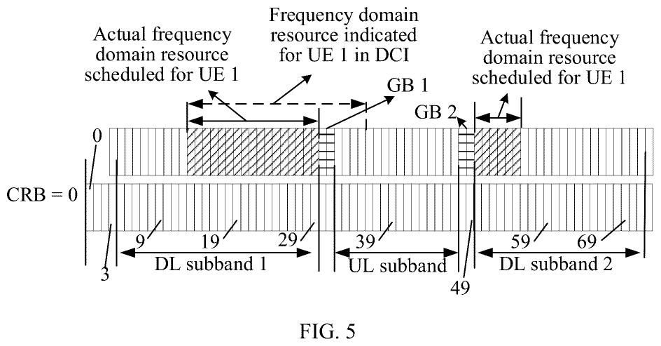

As shown in FIG. 5, frequency domain resources scheduled or semi-statically configured by a network for UE 1 are PRBs 13 to 35, and the frequency resources overlap a UL subband and a GB by six PRBs. The UE considers that frequency resources expected to be scheduled by the network are PRBs 13 to 29 and PRBs 50 to 55.

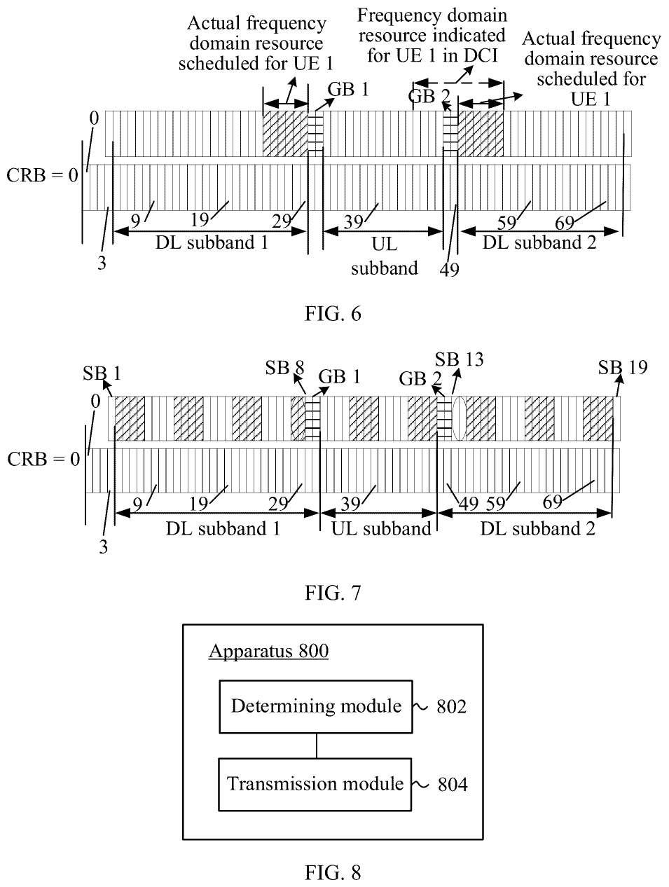

Similarly, as shown in FIG. 6, when frequency domain resources scheduled or semi-statically configured by a network for UE 1 are PRBs 44 to 55, the frequency resources overlap a UL subband and a GB by six PRBs. Based on a frequency domain direction configured by the network, for example, from a high frequency to a low frequency, the UE ignores PRBs overlapping the UL subband and the GB, and determines an allocated resource on a DL subband with a low frequency. That is, it is considered that frequency resources expected to be scheduled by the network are PRBs 24 to 29 and PRBs 50 to 55.

Further, the network may configure a resource overlapping the UL subband or the GB to be determined in a high frequency direction or a low frequency direction.

### Embodiment 4

Manner 3 is mainly described in this embodiment.

In this embodiment, a network configures locations and sizes of a UL subband and a GB. When a subband (SB) configured by the network overlaps the UL subband or the GB, UE discards a PRB in the SB overlapping the UL subband and/or the GB in one SB, and determines a size of the SB based on a quantity of remaining PRBs. The UE uses the SB as one of CSI reporting bands.

For example, a bandwidth of a BWP is 70 PRBs, a start PRB is 3 (relative to a common PRB), and the network configures an SB size as 4.

As shown in FIG. 7, a BWP is divided into 19 SBs, where the first SB (SB 1) and the last SB (SB 19) have only one PRB, and remaining SBs include four PRBs.

The network configures the location of the UL subband as a PRB 32 to a PRB 47, with a total of 16 PRBs.

The network may configure the size and the frequency domain location of the GB in carrier-level or UL subband configuration signaling, or in DL BWP configuration signaling, and an ellipse in FIG. 7 represent actually available PRBs.

For example, the GB is PRBs on both sides of the UL subband. GB: {size 1 (lower frequency), size 2 (Higher frequency)}. In the example of FIG. 4, GB: {2, 2} indicates that two PRBs on the left side of an edge PRB 31 of the UL subband are used as a GB, and two PRBs on the right side of an edge PRB 47 of the UL subband are used as a GB. In this case, two PRBs with a low frequency and two PRBs with a high frequency on both sides of the UL subband are used as GBs.

For another example, GB: {0, . . . , 273} indicates which PRBs are used as GBs in a bitmap form. Bits of 30, 31, 48 and 49 are set to 1, indicating that the four PRBs are used as GBs.

When a gNB configures an SB size, for an SB overlapping the GB or the UL subband, the UE determines that a size of the SB is a quantity of RBs available in the SB, that is, discards a PRB overlapping the GB or UL subband. For example, when the gNB indicates that an SB size is 4, for an SB 8 and an SB 13, sizes of the two SBs respectively include two PRBs. That is, the sizes of the two SBs are 2. The UE also determines this SB including two PRBs as a valid subband of a CSI reporting band, to calculate CSI based on the CSI reporting band.

### Embodiment 5

Manner 4 is mainly described in this embodiment.

In this embodiment, a network configures at least the following parameters for UE in higher-layer parameters:
SB size 1 ENUMERATED {1, 2, 3, . . . , 31}; and
SB size 2 ENUMERATED {1, 2, 3, . . . , 31}.

These parameters are used to indicate a size of SBs overlapping a UL subband or a GB when SB sizes are 4 to 32.

An SB size 1 is used to indicate a size of an SB of a low frequency that overlaps the UL subband or the GB; and an SB size 2 is used to indicate a size of an SB of a high frequency that overlaps the UL subband or the GB.

For example, the network may additionally indicate frequency domain locations of these SBs in addition to indicating SB sizes.

This method may be used when the network does not configure a GB size.

### Embodiment 6

In Embodiment 1, the methods in Embodiment 2 and Embodiment 3 may also be used when a continuous resource allocation type (that is, a type 1) is based on an RBG granularity. In this case:

Manner 1: When a network configures that a UL subband and/or a GB overlap a DL BWP of UE, if the network schedules the UE by using the frequency continuous resource allocation type, that is, the type 1, and a scheduled frequency domain resource overlaps the UL subband and/or the GB, the UE ignores an RBG overlapping the UL subband and the GB in resource allocation. The UE determines a TBS by using a PRB in a non-overlapping RBG and performs reception.

Manner 2: When a network configures that a UL subband and/or a GB overlap a DL BWP of UE, if the network schedules the UE by using the frequency continuous resource allocation type, that is, the type 1, and a scheduled frequency domain resource overlaps the UL subband and/or the GB, the UE skips, based on a frequency domain direction configured by the network, an RBG overlapping the UL subband and the GB until a quantity of valid DL RBGs is equal to an RBG quantity indicated in frequency domain resource allocation. The UE determines a PRB quantity based on RBGs allocated in frequency resource allocation, determines a TBS, and performs reception.

If one RBG partially overlaps the UL subband or the GB, the UE discards the RBG.

### Embodiment 7

The method in Embodiment 6 may also be used for UL continuous resource allocation of an uplink-downlink-uplink (UDU) scenario in a full duplex (full duplex) scenario.

### Embodiment 8

In this embodiment, when a DL is scheduled, if overlapping with a GB or a UL subband occurs during initial transmission and no overlapping with the GB or the UL subband occurs during retransmission, or no overlapping with a GB or a UL subband occurs during initial transmission and overlapping with the GB or the UL subband occurs during retransmission, UE expects to determine that quantities of PRBs of TBSs are the same.

### Embodiment 9

In this embodiment, a network may configure UE. If overlapping with a UL subband or a GB occurs during DL scheduling, the UE performs rate matching on the overlapping UL subband or GB, that is, a TBS is determined by using a non-overlapping PRB.

### Embodiment 10

In this embodiment, a network may indicate a scaling factor “alpha” by means of semi-static configuration or adding an indicator field to DCI.

When a scheduled frequency domain resource overlaps a UL subband and/or a GB, UE determines a PRB quantity based on the scaling factor, to determine a TBS and perform reception.

The UE skips, based on a frequency domain direction configured by the network, PRBs overlapping the UL subband and the GB until a quantity of available PRBs is equal to allocated PRB*alpha.

An example is: quantity of available PRBs=quantity of allocated PRBs*alpha.

For example, the network may configure that the scaling factor is only used in an SBFD slot.

### Embodiment 11

In this embodiment, a network may indicate a reference PRB quantity by means of semi-static configuration or adding an indicator field to DCI.

When a scheduled frequency domain resource overlaps a UL subband and/or a GB, UE uses the reference PRB quantity closest to allocated PRBs as an actual PRB quantity, and determines a TBS based on the actual PRB quantity and performs reception.

The UE skips, based on a frequency domain direction configured by the network, PRBs overlapping the UL subband and the GB until a quantity of available PRBs is equal to the closest reference PRB quantity.

The network may configure that a reference PRB is only used in an SBFD slot.

The frequency domain resource determining method provided in the embodiments of this application may be executed by a frequency domain resource determining apparatus. In the embodiments of this application, an example in which the frequency domain resource determining apparatus executes the frequency domain resource determining method is used to describe the frequency domain resource determining apparatus provided in the embodiments of this application.

FIG. 8 is a schematic structural diagram of a frequency domain resource determining apparatus according to an embodiment of this application. The apparatus may correspond to a terminal or a network side device in another embodiment. As shown in FIG. 8, the apparatus 800 includes the following modules:
a determining module 802, configured to: in a case that a frequency domain resource scheduled by a network side device overlaps a first subband and/or a GB, determine valid PRBs of the frequency domain resource based on a first mode or a second mode, where
the frequency domain resource is located in a first BWP, a transmission direction of the first subband is different from a transmission direction of the first BWP, and the first mode includes: ignoring PRBs overlapping the first subband and/or the GB in the frequency domain resource, and determining remaining PRBs as valid PRBs; and the second mode includes: skipping PRBs overlapping the first subband and/or the GB until a quantity of valid PRBs is equal to a target PRB quantity; and
a transmission module 804, configured to: determine a TBS based on the valid PRBs, and perform information transmission based on the TBS.

According to the frequency domain resource determining apparatus provided in this embodiment of this application, in a case that a frequency domain resource scheduled by a network side device overlaps a first subband and/or a GB, the frequency domain resource is located in a first BWP, and a transmission direction of the first subband is different from a transmission direction of the first BWP, PRBs overlapping the first subband and/or the GB in the frequency domain resource may be ignored, and remaining PRBs are determined as valid PRBs; or PRBs overlapping the first subband and/or the GB are skipped until a quantity of valid PRBs is equal to a target PRB quantity; and a TBS is determined based on the valid PRB, and information transmission is performed based on the TBS. In this embodiment of this application, the frequency domain resource scheduled by the network side device can be fully utilized, thereby improving utilization of the frequency domain resource. In addition, in this embodiment of this application, full-duplex configurations that meet different service volume requirements in NR can be implemented, thereby improving system resource utilization and reducing a delay.

For example, in an embodiment, the target PRB quantity includes one of the following: (1) a PRB quantity indicated in frequency domain resource allocation; (2) a product of a PRB quantity indicated in frequency domain resource allocation and a scaling factor; and (3) a reference quantity closest to a PRB quantity indicated in frequency domain resource allocation, where the reference quantity is configured or indicated by the network side device.

For example, in an embodiment, the determining module 802 is configured to skip, based on a frequency domain direction configured by the network side device, the PRB overlapping the first subband and/or the GB until the quantity of valid PRBs is equal to the target PRB quantity.

For example, in an embodiment, an allocation type of the frequency domain resource is a continuous resource allocation type.

The apparatus 800 according to this embodiment of this application may correspond to the procedures of the method 200 in the embodiments of this application, and the units/modules in the apparatus 800 and the foregoing operations and/or functions are separately for implementing the corresponding procedures of the method 200, and can achieve a same or equivalent technical effect. For brevity, details are not described herein again.

The frequency domain resource determining apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a Network Attached Storage (NAS), or the like. This is not limited in this embodiment of this application.

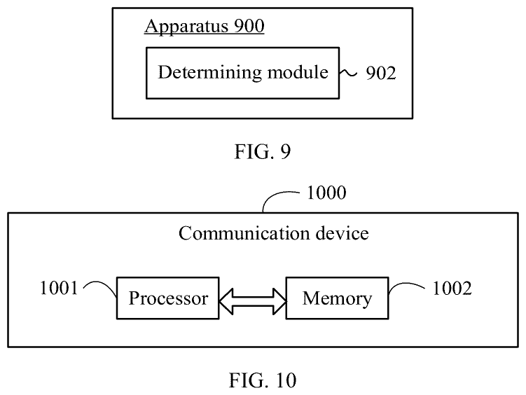

FIG. 9 is a schematic structural diagram of a frequency domain resource determining apparatus according to an embodiment of this application. The apparatus may correspond to a terminal or a network side device in another embodiment. As shown in FIG. 9, the apparatus 900 includes the following module:
a determining module 902, configured to: in a case that a second subband configured by a network side device overlaps a third subband and/or a GB, determine a size of the second subband based on a third mode or a fourth mode, where a transmission direction of the second subband is different from a transmission direction of the third subband, and the third mode includes: discarding a PRB overlapping the third subband and/or the GB in the second subband, and determining the size of the second subband based on remaining PRBs; and the fourth mode includes: determining the size of the second subband based on a configuration of the network side device.

For example, the apparatus further includes a communication module.

According to the frequency domain resource determining apparatus provided in this embodiment of this application, in a case that a second subband configured by a network side device overlaps a third subband and/or a GB, and a transmission direction of the second subband is different from a transmission direction of the third subband, a PRB overlapping the third subband and/or the GB in the second subband may be discarded, and a size of the second subband may be determined based on remaining PRBs; or a size of the second subband is determined based on a configuration of the network side device. In this embodiment of this application, a frequency domain resource of a subband configured by the network side device can be fully utilized, thereby improving utilization of the frequency domain resource. In addition, in this embodiment of this application, full-duplex configurations that meet different service volume requirements in NR can be implemented, thereby improving system resource utilization and reducing a delay.

For example, in an embodiment, the determining module 902 is further configured to: determine the second subband as a valid subband of a CSI reporting band, and calculate CSI based on the CSI reporting band.

For example, in an embodiment, the apparatus further includes a communication module, configured to transmit or receive configuration information, where the configuration information is used to configure at least one of the following: (1) the size of the second subband; and (2) a frequency domain location of the second subband.

The apparatus 900 according to this embodiment of this application may correspond to the procedures of the method 300 in the embodiments of this application, and the units/modules in the apparatus 900 and the foregoing operations and/or functions are separately for implementing the corresponding procedures of the method 300, and can achieve a same or equivalent technical effect. For brevity, details are not described herein again.

The frequency domain resource determining apparatus provided in this embodiment of this application can implement the processes implemented in the method embodiments of FIG. 2 to FIG. 3, and achieve a same technical effect. To avoid repetition, details are not described herein again.

For example, as shown in FIG. 10, an embodiment of this application further provides a communication device 1000, including a processor 1001 and a memory 1002. The memory 1002 stores a program or an instruction that can be run on the processor 1001. For example, when the communication device 1000 is a terminal, the program or the instruction is executed by the processor 1001 to implement the steps of the foregoing frequency domain resource determining method embodiment, and can achieve a same technical effect. When the communication device 1000 is a network side device, the program or the instruction is executed by the processor 1001 to implement the steps of the foregoing frequency domain resource determining method embodiment, and a same technical effect can be achieved. To avoid repetition, details are not described herein again.

An embodiment of this application further provides a terminal, including a processor and a communication interface. The processor is configured to: in a case that a frequency domain resource scheduled by a network side device overlaps a first subband and/or a GB, determine valid PRBs of the frequency domain resource based on a first mode or a second mode; and the communication interface is configured to: determine a TBS based on the valid PRBs, and perform information transmission based on the TBS, where the frequency domain resource is located in a first BWP, a transmission direction of the first subband is different from a transmission direction of the first BWP, and the first mode includes: ignoring PRBs overlapping the first subband and/or the GB in the frequency domain resource, and determining remaining PRBs as valid PRBs; and the second mode includes: skipping PRBs overlapping the first subband and/or the GB until a quantity of valid PRBs is equal to a target PRB quantity. In some embodiments, the processor is configured to: in a case that a second subband configured by a network side device overlaps a third subband and/or a GB, determine a size of the second subband based on a third mode or a fourth mode, where a transmission direction of the second subband is different from a transmission direction of the third subband, and the third mode includes: discarding a PRB overlapping the third subband and/or the GB in the second subband, and determining the size of the second subband based on remaining PRBs; and the fourth mode includes: determining the size of the second subband based on a configuration of the network side device.

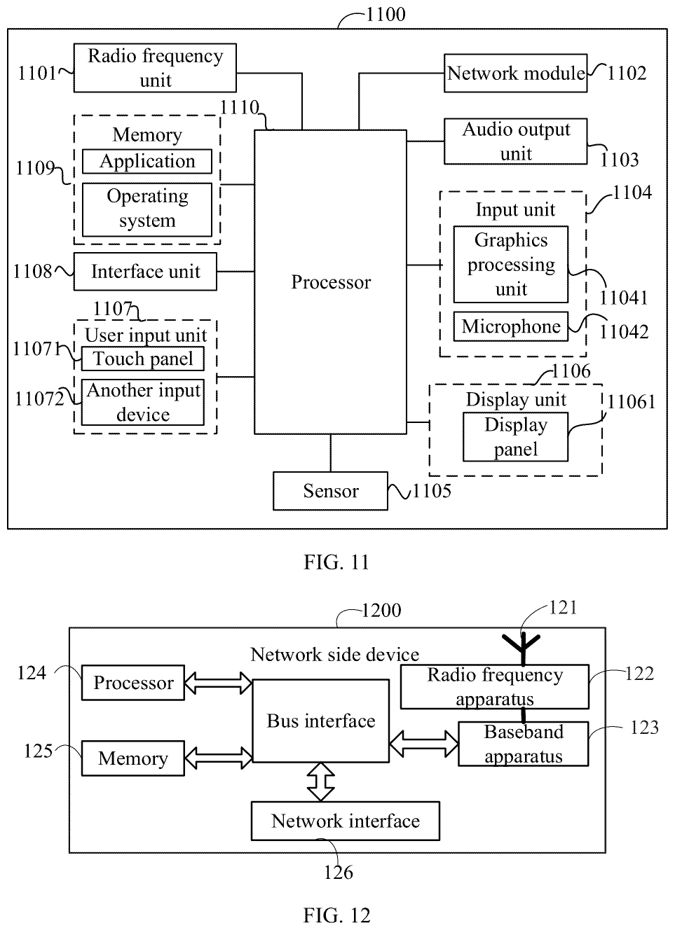

This terminal embodiment corresponds to the foregoing method embodiment on the terminal side. Each implementation process and implementation of the foregoing method embodiment may be applicable to this terminal embodiment, and a same technical effect can be achieved. For example, FIG. 11 is a schematic structural diagram of hardware of a terminal according to an embodiment of this application.

The terminal 1100 includes but is not limited to components such as a radio frequency unit 1101, a network module 1102, an audio output unit 1103, an input unit 1104, a sensor 1105, a display unit 1106, a user input unit 1107, an interface unit 1108, a memory 1109, and a processor 1110.

It is understood that the terminal 1100 may further include the power supply (for example, a battery) that supplies power to each component. The power supply may be logically connected to the processor 1110 by using a power supply management system, so as to manage functions such as charging, discharging, and power consumption by using the power supply management system. The terminal structure shown in FIG. 11 constitutes no limitation on the terminal, and the terminal may include more or fewer components than those shown in the figure, or combine some components, or have different component arrangements. Details are not described herein.

It should be understood that, in this embodiment of this application, the input unit 1104 may include a Graphics Processing Unit (GPU) 11041 and a microphone 11042, and the graphics processing unit 11041 processes image data of a still image or a video that is obtained by an image capturing apparatus (for example, a camera) in a video capturing mode or an image capturing mode. The display unit 1106 may include a display panel 11061. The display panel 11061 may be configured in a form such as a liquid crystal display or an organic light-emitting diode. The user input unit 1107 includes at least one of a touch panel 11071 and another input device 11072. The touch panel 11071 is also referred to as a touchscreen. The touch panel 11071 may include two parts: a touch detection apparatus and a touch controller. The another input device 11072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1101 may transmit the downlink data to the processor 1110 for processing. In addition, the radio frequency unit 1101 may send uplink data to the network side device. Usually, the radio frequency unit 1101 includes but is not limited to an antenna, an amplifier, a transceiver, a coupler, a low noise amplifier, a duplexer, and the like.

The memory 1109 may be configured to store a software program or an instruction and various data. The memory 1109 may mainly include a first storage area for storing a program or an instruction and a second storage area for storing data. The first storage area may store an operating system, and an application or an instruction required by at least one function (for example, a sound playing function or an image playing function). In addition, the memory 1109 may be a volatile memory or a non-volatile memory, or the memory 1109 may include a volatile memory and a non-volatile memory. The nonvolatile memory may be a Read-Only Memory (ROM), a programmable read-only memory (PROM), an erasable programmable read-only memory (EPROM), an electrically erasable programmable read-only memory (EEPROM), or a flash memory. The volatile memory may be a Random Access Memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), and a direct rambus random access memory (DRRAM). The memory 1109 in this embodiment of this application includes but is not limited to these memories and a memory of any other proper type.

The processor 1110 may include one or more processing units. For example, an application processor and a modem processor are integrated into the processor 1110. The application processor mainly processes an operating system, a user interface, an application, and the like. The modem processor mainly processes a wireless communication signal, for example, a baseband processor. It can be understood that, for example, the modem processor may not be integrated into the processor 1110.

The processor 1110 may be configured to: in a case that a frequency domain resource scheduled by a network side device overlaps a first subband and/or a GB, determine valid PRBs of the frequency domain resource based on a first mode or a second mode; and the radio frequency unit 1101 may be configured to: determine a TBS based on the valid PRBs, and perform information transmission based on the TBS, where the frequency domain resource is located in a first BWP, a transmission direction of the first subband is different from a transmission direction of the first BWP, and the first mode includes: ignoring PRBs overlapping the first subband and/or the GB in the frequency domain resource, and determining remaining PRBs as valid PRBs; and the second mode includes: skipping PRBs overlapping the first subband and/or the GB until a quantity of valid PRBs is equal to a target PRB quantity. In some embodiments, the processor 1110 may be configured to: in a case that a second subband configured by a network side device overlaps a third subband and/or a GB, determine a size of the second subband based on a third mode or a fourth mode, where a transmission direction of the second subband is different from a transmission direction of the third subband, and the third mode includes: discarding a PRB overlapping the third subband and/or the GB in the second subband, and determining the size of the second subband based on remaining PRBs; and the fourth mode includes: determining the size of the second subband based on a configuration of the network side device.

In this embodiment of this application, the frequency domain resource scheduled by the network side device can be fully utilized, thereby improving utilization of the frequency domain resource. In addition, in this embodiment of this application, full-duplex configurations that meet different service volume requirements in NR can be implemented, thereby improving system resource utilization and reducing a delay.

The terminal 1100 provided in this embodiment of this application may further implement the processes of the foregoing frequency domain resource determining method embodiment, and can achieve a same technical effect. To avoid repetition, details are not described herein again.

An embodiment of this application further provides a network side device, including a processor and a communication interface. The processor is configured to: in a case that a frequency domain resource scheduled by a network side device overlaps a first subband and/or a GB, determine valid PRBs of the frequency domain resource based on a first mode or a second mode; and the communication interface is configured to: determine a TBS based on the valid PRBs, and perform information transmission based on the TBS, where the frequency domain resource is located in a first BWP, a transmission direction of the first subband is different from a transmission direction of the first BWP, and the first mode includes: ignoring PRBs overlapping the first subband and/or the GB in the frequency domain resource, and determining remaining PRBs as valid PRBs; and the second mode includes: skipping PRBs overlapping the first subband and/or the GB until a quantity of valid PRBs is equal to a target PRB quantity. In some embodiments, the processor is configured to: in a case that a second subband configured by a network side device overlaps a third subband and/or a GB, determine a size of the second subband based on a third mode or a fourth mode, where a transmission direction of the second subband is different from a transmission direction of the third subband, and the third mode includes: discarding a PRB overlapping the third subband and/or the GB in the second subband, and determining the size of the second subband based on remaining PRBs; and the fourth mode includes: determining the size of the second subband based on a configuration of the network side device.

This network side device embodiment corresponds to the foregoing method embodiment on the network side device. Each implementation process and implementation of the foregoing method embodiment may be applicable to this network side device embodiment, and a same technical effect can be achieved.

For example, an embodiment of this application further provides a network side device. As shown in FIG. 12, the network side device 1200 includes an antenna 121, a radio frequency apparatus 122, a baseband apparatus 123, a processor 124, and a memory 125. The antenna 121 is connected to the radio frequency apparatus 122. In an uplink direction, the radio frequency apparatus 122 receives information by using the antenna 121, and sends the received information to the baseband apparatus 123 for processing. In a downlink direction, the baseband apparatus 123 processes information that needs to be sent, and sends processed information to the radio frequency apparatus 122. The radio frequency apparatus 122 processes the received information, and sends processed information by using the antenna 121.

In the foregoing embodiment, the method performed by the network side device may be implemented in the baseband apparatus 123. The baseband apparatus 123 includes a baseband processor.

The baseband apparatus 123 may include, for example, at least one baseband board, where a plurality of chips are disposed on the baseband board. As shown in FIG. 12, one chip is, for example, the baseband processor, is connected to the memory 125 through a bus interface, to invoke a program in the memory 125 to perform the operations of the network device shown in the foregoing method embodiment.

The network side device may further include a network interface 126, and the interface is, for example, a common public radio interface (CPRI).

For example, the network side device 1200 in this embodiment of this application further includes an instruction or a program that is stored in the memory 125 and that can be run on the processor 124. The processor 124 invokes the instruction or the program in the memory 125 to perform the method performed by the modules shown in FIG. 8 or FIG. 9, and a same technical effect is achieved. To avoid repetition, details are not described herein again.

An embodiment of this application further provides a readable storage medium. The readable storage medium stores a program or an instruction, and the program or the instruction is executed by a processor to implement the processes of the foregoing frequency domain resource determining method embodiment, and a same technical effect can be achieved. To avoid repetition, details are not described herein again.

The processor is a processor in the terminal in the foregoing embodiment. The readable storage medium may be non-volatile or may be non-transient. The readable storage medium includes a computer readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing frequency domain resource determining method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a storage medium, and the program/program product is executed by at least one processor to implement the processes of the foregoing frequency domain resource determining method embodiment, and a same technical effect can be achieved. To avoid repetition, details are not described herein again.

An embodiment of this application further provides a frequency domain resource determining system, including a terminal and a network side device. The terminal may be configured to perform the steps of the foregoing frequency domain resource determining method, and the network side device may be configured to perform the steps of the foregoing frequency domain resource determining method.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the method in the foregoing embodiment may be implemented by software in addition to a necessary universal hardware platform or by hardware only. In most circumstances, the former is an example implementation manner. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the above specific implementations, and the above specific implementations are merely illustrative but not restrictive. Under the enlightenment of this application, a person of ordinary skill in the art can make many forms without departing from the purpose of this application and the protection scope of the claims, all of which fall within the protection of this application.

1. A frequency domain resource determining method, comprising:
when a frequency domain resource scheduled by a network side device overlaps at least one of a first subband or a guard band (GB), determining, by a communication device, valid physical resource blocks (PRBs) of the frequency domain resource based on a first mode or a second mode; and
determining, by the communication device, a transport block size (TBS) based on the valid PRBs, and performing information transmission based on the TBS, wherein
the frequency domain resource is located in a first bandwidth part (BWP), a transmission direction of the first subband is different from a transmission direction of the first BWP, and the first mode comprises: ignoring PRBs overlapping the at least one of the first subband or the GB in the frequency domain resource, and determining remaining PRBs as valid PRBs; and the second mode comprises: skipping PRBs overlapping the at least one of the first subband or the GB until a quantity of valid PRBs is equal to a target PRB quantity.

2. The method according to claim 1, wherein the target PRB quantity comprises one of the following:
a PRB quantity indicated in frequency domain resource allocation;
a product of a PRB quantity indicated in frequency domain resource allocation and a scaling factor; or
a reference quantity closest to a PRB quantity indicated in frequency domain resource allocation, wherein the reference quantity is configured or indicated by the network side device.

3. The method according to claim 1, wherein the skipping PRBs overlapping the at least one of the first subband or the GB until a quantity of valid PRBs is equal to a target PRB quantity comprises:
skipping, based on a frequency domain direction configured by the network side device, the PRBs overlapping the at least one of the first subband or the GB until the quantity of valid PRBs is equal to the target PRB quantity.

4. The method according to claim 1, wherein an allocation type of the frequency domain resource is a continuous resource allocation type.

5. A terminal, comprising a processor and a memory, wherein the memory stores a program or an instruction that is configured to be run on the processor, and the program or the instruction is executed by the processor to perform operations comprising:
when a frequency domain resource scheduled by a network side device overlaps at least one of a first subband or a guard band (GB), determining, by the terminal, valid physical resource blocks (PRBs) of the frequency domain resource based on a first mode or a second mode; and
determining, by the terminal, a transport block size (TBS) based on the valid PRBs, and performing information transmission based on the TBS, wherein
the frequency domain resource is located in a first bandwidth part (BWP), a transmission direction of the first subband is different from a transmission direction of the first BWP, and the first mode comprises: ignoring PRBs overlapping the at least one of the first subband or the GB in the frequency domain resource, and determining remaining PRBs as valid PRBs; and the second mode comprises: skipping PRBs overlapping the at least one of the first subband or the GB until a quantity of valid PRBs is equal to a target PRB quantity.

6. The terminal according to claim 5, wherein the target PRB quantity comprises one of the following:
a PRB quantity indicated in frequency domain resource allocation;
a product of a PRB quantity indicated in frequency domain resource allocation and a scaling factor; or
a reference quantity closest to a PRB quantity indicated in frequency domain resource allocation, wherein the reference quantity is configured or indicated by the network side device.

7. The terminal according to claim 5, wherein the skipping PRBs overlapping the at least one of the first subband or the GB until a quantity of valid PRBs is equal to a target PRB quantity comprises:
skipping, based on a frequency domain direction configured by the network side device, the PRBs overlapping the at least one of the first subband or the GB until the quantity of valid PRBs is equal to the target PRB quantity.

8. The terminal according to claim 5, wherein an allocation type of the frequency domain resource is a continuous resource allocation type.

9. A non-transitory readable storage medium, wherein the readable storage medium stores a program or an instruction, and the program or the instruction is executed by a processor to perform operations comprising:
when a frequency domain resource scheduled by a network side device overlaps at least one of a first subband or a guard band (GB), determining, by the terminal, valid physical resource blocks (PRBs) of the frequency domain resource based on a first mode or a second mode; and
determining, by the terminal, a transport block size (TBS) based on the valid PRBs, and performing information transmission based on the TBS, wherein
the frequency domain resource is located in a first bandwidth part (BWP), a transmission direction of the first subband is different from a transmission direction of the first BWP, and the first mode comprises: ignoring PRBs overlapping the at least one of the first subband or the GB in the frequency domain resource, and determining remaining PRBs as valid PRBs; and the second mode comprises: skipping PRBs overlapping the at least one of the first subband or the GB until a quantity of valid PRBs is equal to a target PRB quantity.

10. The non-transitory readable storage medium according to claim 9, wherein the target PRB quantity comprises one of the following:
a PRB quantity indicated in frequency domain resource allocation;
a product of a PRB quantity indicated in frequency domain resource allocation and a scaling factor; or
a reference quantity closest to a PRB quantity indicated in frequency domain resource allocation, wherein the reference quantity is configured or indicated by the network side device.

11. The non-transitory readable storage medium according to claim 9, wherein the skipping PRBs overlapping the at least one of the first subband or the GB until a quantity of valid PRBs is equal to a target PRB quantity comprises:
skipping, based on a frequency domain direction configured by the network side device, the PRBs overlapping the at least one of the first subband or the GB until the quantity of valid PRBs is equal to the target PRB quantity.

12. The non-transitory readable storage medium according to claim 9, wherein an allocation type of the frequency domain resource is a continuous resource allocation type.
